(19) United States
(12) Patent Application Publication
(10) Pub. No.: US 2016/0338395 A1
(43) Pub. Date: Nov. 24, 2016

(54) FROZEN COOKED NOODLES AND METHOD FOR MANUFACTURING SAME

(71) Applicant: NISSHIN FOODS INC., Tokyo (JP)

(72) Inventors: Kanako KAWATA, Fujimino-shi (JP); Takaaki MIYAJIMA, Fujimino-shi (JP); Kentarou IRIE, Fujimino-shi (JP); Kazuko KOJIMA, Fujimino-shi (JP); Toshiyuki MIYAZAKI, Fujimino-shi (JP)

(73) Assignee: NISSHIN FOODS INC., Tokyo (JP)

(21) Appl. No.: 15/113,918

(22) PCT Filed: Jan. 26, 2015
(86) PCT No.: PCT/JP2015/052024

§ 371 Date: Jul. 25, 2016

(30) Foreign Application Priority Data
Jan. 31, 2014 (JP) 2014-017248

(51) Int. Cl. A23L 19/10; A23L 3/36

(52) U.S. Cl. CPC A23L 19/11; A23L 3/36; A23V 2002/00

(57) ABSTRACT

Provided is frozen cooked noodles capable of maintaining a favorable texture even after thawing. A method for manufacturing frozen cooked noodles, comprising: obtaining noodles produced from raw material flour comprising 5 to 80% by mass of processed tapioca starch; gelatinizing the noodles; allowing a composition comprising collagen peptides to attach to the gelatinized noodles thus obtained; and freezing the noodles attached with the composition.

### TECHNICAL FIELD

The present invention relates to frozen cooked noodles and a method for manufacturing the same.

### BACKGROUND ART

In general, frozen cooked noodles are manufactured by boiling noodles produced from ingredients such as wheat flour, cooling the boiled noodles with water and then quickly freezing the cooled noodles. The noodles before freezing normally contain a large amount of water resulting from the aforementioned boiling and water-cooling steps. However, when noodles with high water content are frozen, it takes time for the temperature of noodles to pass the freezing point (approximately 0 to −5° C.) during freezing and thawing, consequently promoting the retrogradation of starch contained in the noodles. Thus, conventional frozen cooked noodles have a problem that the noodles are hardened due to retrogradation of starch and the texture thereof is deteriorated. This problem is more noticeable with frozen noodles which are slowly thawed under non-heating conditions, for example, by natural thawing, as compared with frozen noodles which are quickly thawed under heating conditions, for example, by microwaving. Particularly, there is a problem in noodles which are slowly thawed after long-term frozen storage that retrogradation is further promoted, resulting in a hard yet brittle, inelastic and crumbly texture.

Methods for improving the texture of frozen cooked noodles have been proposed previously. For example, Patent Literature 1 discloses that frozen gelatinized noodles manufactured from a composition containing wheat flour, starch and curdlan retain a favorable texture even after thawing with running water or slow thawing. Also, Patent Literature 2 discloses that frozen gelatinized noodles manufactured from raw material flour containing wheat flour with a crude protein content of 12% or more, processed tapioca starch and gluten retain a favorable texture even after thawing at refrigeration temperature or slow thawing. Patent Literature 3 discloses that noodle strands are boiled by intermittently immersing them in hot water to increase the gelatinization degree of the noodles, to thereby compensate for a reduced gelatinization degree caused by retrogradation of noodles occurring during slow thawing, resulting in prevention of the deteriorated texture of the noodles. Patent Literature 4 discloses that by coating noodle strands with gelatin, the deteriorated texture of soggy noodles is prevented and the noodle strands are easily untangled after thawing. Patent Literature 5 discloses that by incorporating collagen peptides into creamy foods containing starchy materials as the main component (for example, macaroni au gratin), the creamy state can be maintained even when the foods are cooked after frozen-storage.

However, when the aforementioned noodles were frozen-stored for a long time, the noodles after thawing had unsatisfactory elasticity. Moreover, when the aforementioned noodles were frozen-stored with sauces and dressings, separation of water occurred and the sauces and dressings after thawing became partly watery, resulting in further unfavorable consequences. In light of the above, there is a demand for further methods for improving the texture of frozen cooked noodles after thawing. Frozen cooked noodles capable of maintaining a favorable texture comparable to that of noodles before freezing even after they are slowly thawed after frozen-storage, particularly frozen-storage with sauces and dressings, are desired.

### CITATION LIST

### Patent Literature

[Patent Literature 1] JP-A-2000-342207
[Patent Literature 2] JP-A-10-042811
[Patent Literature 3] JP-A-2001-252036
[Patent Literature 4] JP-A-63-283547
[Patent Literature 5] JP-A-2002-223731

### SUMMARY OF INVENTION

### Technical Problem

An object of the present invention is to provide frozen cooked noodles which are prevented from deterioration in quality and maintain a favorable texture even after they are slowly thawed by, for example, natural thawing at room temperature or thawing with running water.

### Solution to Problem

The present inventors conducted various studies in order to achieve the aforementioned object. As a result, they have found that frozen cooked noodles capable of maintaining a favorable texture even after slow thawing can be manufactured by gelatinizing noodles produced from raw materials containing processed tapioca starch, then allowing a composition containing collagen peptides to attach to the noodles, and then freezing the noodles, thereby completing the present invention.

That is, the present invention provides a method for manufacturing frozen cooked noodles, comprising: obtaining noodles produced from raw material flour comprising 5 to 80% by mass of processed tapioca starch; gelatinizing the noodles; allowing a composition containing collagen peptides to attach to the gelatinized noodles thus obtained; and freezing the noodles attached with the composition.

The present invention also provides a method for manufacturing cooked noodles, comprising thawing the aforementioned frozen cooked noodles.

### Advantageous Effects of Invention

The frozen cooked noodles obtained by the production method of the present invention can maintain a favorable texture comparable to that of noodles before freezing even after thawing, particularly after slow thawing. The frozen cooked noodles obtained by the production method of the present invention do not become soft, and retain a smooth and elastic, favorable texture, even after they are slowly thawed after long-term frozen storage.

### DESCRIPTION OF EMBODIMENTS

In the present description, noodles refer to a food obtained by molding dough prepared by kneading raw material flour containing grain flour and starch, and a type and shape thereof are not particularly limited. Examples of the noodles in the present description include so-called noodle strands such as Japanese thick noodles (udon), Japanese buckwheat noodles (soba), Chinese noodles and long pasta; short pastas such as macaroni and penne; flat pastas; and dough wrappers such as wrappers for Chinese dumpling wrappers (gyoza) and spring rolls (harumaki).

In the present invention, the noodles used for manufacturing frozen cooked noodles are noodles produced from raw material flour containing processed tapioca starch. Tapioca starch is starch manufactured from the rhizome of cassava of the family Euphorbiaceae. Processed tapioca starch can be manufactured by treating the tapioca starch by chemical processing or chemical modification. As the chemical processing or chemical modification, a known method such as esterification, etherification and cross-linking can be used. Examples of esterified tapioca starch include acetylated tapioca starch, phosphorylated tapioca starch and octenyl succinic acid-modified tapioca starch. Examples of etherified tapioca starch include hydroxypropylated tapioca starch and carboxymethylated tapioca starch. Examples of cross-linked tapioca starch include phosphoric acid cross-linked tapioca starch and glycerol cross-linked tapioca starch.

Acetylated tapioca starch can be manufactured by, for example, reacting tapioca starch with acetic anhydride. Phosphoric acid cross-linked tapioca starch can be manufactured by, for example, cross-linking tapioca starch and phosphorus oxychloride. Hydroxypropylated tapioca starch can be manufactured by, for example, etherifying tapioca starch with propylene oxide.

The raw material flour may contain any one of the processed tapioca starches singly or two or more of them in combination. The processed tapioca starch contained in the raw material flour may be preferably one or more selected from the group consisting of esterified tapioca starch, etherified tapioca starch, and cross-linked tapioca starch, more preferably one or more selected from the group consisting of esterified tapioca starch and etherified tapioca starch, even more preferably one or more selected from the group consisting of acetylated tapioca starch and hydroxypropylated tapioca starch.

The content of the processed tapioca starch in the raw material flour may be from 5 to 80% by mass, preferably from 20 to 60% by mass of the total amount of the raw material flour. When the content of the processed tapioca starch is less than 5% by mass, the frozen cooked noodles after thawing lose smoothness and elasticity, resulting in a hard texture. On the other hand, when the content exceeds 80% by mass, the frozen cooked noodles after thawing lack smoothness and elasticity resulting in an exceedingly soft texture.

Also, the raw material flour may contain, in addition to the processed tapioca starch, grain flour commonly used for producing noodles, such as wheat flour, durum wheat flour, durum semolina flour, udon noodle flour, buckwheat flour and rice flour. The content of the aforementioned grain flour in the raw material flour may be from 18 to 95% by mass of the total amount of the raw material flour. When the content of grain flour is less than 18% by mass, the taste and flavor of noodles are deteriorated. On the other hand, when the content of grain flour exceeds 95% by mass, the texture of the frozen cooked noodles after thawing is not improved.

The aforementioned noodles may further contain, in addition to the processed tapioca starch and the grain flour, other ingredients commonly used for producing noodles, such as gluten, starch other than the processed tapioca starch, an egg, an emulsifier, a viscosity adjusting agent, and a seasoning. The content of the other ingredients in the noodles is 30% by mass or less relative to 100% by mass of the raw material flour.

The noodles can be produced by molding, by a common method, dough prepared by kneading the raw material flour and, if necessary, the other ingredients with water in accordance with a common method. For example, noodles of predetermined shape can be produced by adding the raw material flour with the other ingredients as needed and an adequate amount of water (for example, from 20 to 55 parts by mass of water relative to 100 parts by mass of raw material flour and other ingredients), followed by kneading to prepare dough, and subsequently, rolling out and then cutting the dough thus obtained. Alternatively, noodles of predetermined shape can be produced by extruding the dough obtained by the procedure mentioned above through a die with small holes. These noodles may be provided as semi-fresh noodles or dried noodles, which are produced by further subjecting the noodles to a drying step, or as fresh noodles, which are produced without a drying step.

Alternatively, the noodles used in the method for manufacturing frozen cooked noodles of the present invention may be a commercially available fresh noodles, semi-fresh noodles or dried noodles as long as they are produced from raw material flour containing the processed tapioca starch in the amounts specified above.

In the present invention, the noodles prepared by the procedure mentioned above are then gelatinized. A method for gelatinizing the noodles is not particularly limited as long as it is a method capable of gelatinizing starch in the noodles, and any known gelatinization method may be adopted. For example, gelatinization of the noodles can be carried out by a method of boiling the noodles by immersing them in hot water, a method of steaming the noodles, a combination of these methods and the like. The noodles thus gelatinized are then cooled after removing sliminess left on the noodle surface, as needed, by washing with water. Cooling can be carried out by a known method such as water cooling and wind cooling.

The gelatinized noodles are then brought into contact with a composition containing collagen peptides. By this operation, the collagen peptide-containing composition is attached to the gelatinized noodles. A means for bringing the collagen peptide-containing composition into contact with the gelatinized noodles is preferably a means capable of allowing the composition to attach to the entire surface of the noodles, and examples of such means include spraying, spreading, immersing, and adding and mixing. Among them, from the viewpoint of economic and simplicity, spraying or adding and mixing are preferable.

The collagen peptide-containing composition may be a composition having collagen peptides dissolved therein, and the composition may be in a liquid form, a solid form, a semi-solid form, a sol form or a gel form. The collagen peptides contained in the composition may be collagen peptides commonly used in foods. For example, hydrolysates of animal-derived gelatin and collagen prepared from bones and skin of cattle, shark cartilage, bones and skin of pig, and so on can be used. Examples of a method of hydrolysis include a method using enzymes such as papain, a method involving treating with acid or alkali, and a method involving heating. However, when the hydrolysis of gelatin and collagen is continued as described above, they are eventually degraded to amino acids (a molecular weight of approximately 100). Since collagen peptides and amino acids have different properties, collagen peptides which are not degraded to amino acids are used in the present invention. As collagen peptides preferably used in the present invention, those having an average molecular weight of 2,000 to 50,000 can be used, and more preferably, those having an average molecular weight of 8,000 to 50,000 can be used.

The average molecular weight of collagen peptides can be measured in accordance with the photographic gelatin test method (PAGI method: the photographic gelatin test method, 10th edition, 2006). The PAGI method is a method for estimating the molecular weight distribution by obtaining a chromatogram of an aqueous solution of collagen by gel filtration using high-performance liquid chromatography. An example of a more detailed procedure is as follows.

(1) Place 2 g of a sample into a 100 mL graduated flask, add thereto an eluent (a mixture containing equal volumes of a 0.1 mol/L solution of potassium dihydrogen phosphate and a 0.1 mol/L solution of disodium hydrogen phosphate), and allow swelling to take place for one hour, followed by dissolving the contents by heating at 40° C. for 60 minutes. After cooling the resulting mixture to room temperature, add an eluent up to the marked line.
(2) Accurately dilute the resulting solution 10-fold with an eluent to obtain a test solution.
(3) Using the test solution, obtain a chromatogram by gel filtration.

Two columns (for example, Shodex Asahipak GS 620 7G) connected in tandem

Flow rate of an eluent: 1.0 mL/min

Column temperature: 50° C.

Detection method: Absorbance at a measurement wavelength of 230 nm

(4) Setting the storage period at the horizontal axis and the corresponding value of absorbance at 230 nm at the vertical axis, draw a molecular weight distribution curve for the sample, from which calculate an average molecular weight.

According to one embodiment, the collage peptide containing composition may be a product dissolving collagen peptides in water, which is in the form of a liquid, a semi-solid, a sol or a gel, and prepared by dissolving collagen peptides in water, and it may be preferably an aqueous collagen peptide solution. The content of collagen peptides in the product dissolving collagen peptides in water is from 0.1 to 8% by mass, preferably from 0.3 to 8% by mass, more preferably from 0.3 to 6% by mass, even more preferably from 1.0 to 6% by mass, even more preferably from 2 to 6% by mass. When the content of collagen peptides in the product dissolving collagen peptides in water is less than 0.1% by mass, the frozen cooked noodles after thawing lose smoothness and elasticity and becomes soft, hence the texture is not improved. Moreover, the appearance of the noodles after thawing is impaired. On the other hand, when the content exceeds 8% by mass, the noodles stick to each other, to become difficult to be loosened after thawing, and to be unevenly thawed.

The amount of the product dissolving collagen peptides in water attached to the gelatinized noodles is 3% by mass or more, preferably 6% by mass or more, more preferably 10% by mass or more relative to 100% by mass of the gelatinized noodles before contact with the product. When the amount of the product attached is less than 3% by mass, attachment to the noodles becomes insufficient, thereby limiting the effect of the present invention. Although there is no particular limitation to the upper limit of the amount of the product attached, when the amount is too excessive, the noodles are embedded in the product dissolving collagen peptides in water, to be difficult to loosen the noodles and the product dissolving collagen peptides in water upon eating. The upper limit of the amount of the product attached is preferably 40% by mass or less, more preferably 30% by mass or less relative to 100% by mass of the gelatinized noodles before contact with the product.

According to another embodiment, the collagen peptide-containing composition may be a collagen peptide-containing sauce prepared by dissolving collagen peptides in a sauce for noodles. As the sauce for noodles, any sauce may be used as long as it is a commonly used sauce for noodles such as a soup, a dressing, a sauce and a dried powder. Examples of the sauce for noodles include, but are not limited to, a tomato-based sauce such as meat sauce and Neapolitan sauce; a white sauce such as carbonara sauce; a brown sauce; an oil-based sauce; a noodle soup (mentsuyu); a stock; a Chinese soup; and dried powder obtained by freeze-drying these sauces. The content of collagen peptides in the collagen peptide-containing sauce is from 0.1 to 8% by mass, preferably from 0.3 to 8% by mass, more preferably from 2 to 8% by mass, even more preferably from 0.3 to 6% by mass, even more preferably from 1.0 to 6% by mass, yet even more preferably from 2 to 6% by mass. When the content of collagen peptides in the collagen peptide-containing sauce is less than 0.1% by mass, the frozen cooked noodles after thawing lose smoothness and elasticity and becomes soft, hence the texture is not improved. Moreover, the appearance of the noodles after thawing is impaired. On the other hand, when the content exceeds 8% by mass, the noodles stick to each other or the noodles and the sauce form a lump, etc., to become difficult to be loosened after thawing and to be unevenly thawed.

The amount of the collagen peptide-containing sauce attached to the gelatinized noodles is 3% by mass or more, preferably 6% by mass or more, more preferably 10% by mass or more relative to 100% by mass of the gelatinized noodles before contact with the sauce. When the amount of the sauce attached is less than 3% by mass, attachment to the noodles becomes insufficient, thereby limiting the effect of the present invention. There is no particular limitation to the upper limit of the amount of the sauce attached, and a form in which the noodles are immersed in a collagen peptide-containing soup, a form in which macaroni is immersed in a collagen peptide-containing gratin sauce, and the like are also encompassed. The upper limit of the amount of the sauce attached is preferably 40% by mass or less, more preferably 30% by mass or less relative to 100% by mass of the gelatinized noodles before contact with the sauce.

The collagen peptide-containing composition or sauce may further contain gelatin. As the gelatin, for example, animal-derived gelatin prepared from bones and skin of cattle, shark cartilage, bones and skin of pig, and so on can be used, preferably one having an average molecular weight of 100,000 or more can be used. The molecular weight of gelatin can be measured by the PAGI method as described above.

Subsequently, the noodles attached with the collagen peptide-containing composition are subjected to a freezing treatment. In the freezing treatment, only the noodles attached with the collagen peptide-containing composition may be frozen, or the noodles may be frozen with the commonly used sauce for noodles mentioned above. For example, in the case of noodles attached with a product dissolving collagen peptides in water, such as an aqueous collagen peptide solution, they may be frozen directly or with the sauce for noodles further added. Also, for example, in the case of noodles attached with a collagen peptide-containing sauce, they may be frozen directly or with the sauce for noodles further added. The sauce for noodles to be further added may be the same kind as or a different kind from the sauce already attached to the noodles. Also, the sauce for noodles to be further added does not need to be attached to the entire noodles.

The sauce for noodles to be further added to noodles attached with the collagen peptide-containing composition or sauce is preferably placed on top of the noodles after they are attached with the collagen peptide-containing composition or sauce. The sauce to be placed on top of noodles is preferably a collagen peptide-containing sauce, or it may further contain gelatin in addition to collagen peptides. The concentration of collagen peptides in the sauce to be placed on top of noodles is preferably lower than that of the collagen peptide-containing composition or sauce to be attached with noodles, preferably from 60 to 80% by mass of the collagen peptide-containing composition or sauce to be attached with noodles. The amount of the sauce to be placed on top of noodles may be appropriately determined according to the eater's preference. When the amount of the sauce to be placed on top is too little, the appearance of noodles after thawing is impaired, while when the amount is too much, it may require time to thaw noodles or uneven thawing may be caused.

The freezing treatment may be either quick freezing or slow freezing; however, quick freezing is preferable. For example, the noodles having a collagen peptide-containing composition adhered thereto may be quickly frozen at −20 to −50° C. When noodles are frozen, they may be frozen in individually sized packages. Once the noodles are frozen, they may be stored under normal frozen-storage conditions, for example, in a freezer at −15° C.

The frozen cooked noodles can be manufactured by the procedure mentioned above. The frozen cooked noodles manufactured in accordance with the method of the present invention may be quickly thawed using a microwave oven and the like before eating, or they may be slowly thawed statically at room temperature. Alternatively, in the case that the frozen noodles are packaged, it is also possible to thaw them with running water by placing the packaged frozen noodles in running water.

The frozen cooked noodles provided by the present invention described above retain a favorable texture comparable to that of noodles which are not frozen even after they are thawed after long-term frozen storage. Particularly, the frozen cooked noodles maintain a smooth and elastic, favorable texture even after they are thawed by slow thawing such as natural thawing at room temperature. The frozen cooked noodles are suitably applied to a lunch box or food materials for take-out foods as frozen food materials intended to be consumed after natural thawing.

### EXAMPLES

Hereinbelow, the present invention will be described further in detail with reference to Examples; however, the present invention is not limited only to these Examples.

### Reference Example 1

### Collagen Peptides

In 4 kg of warm water, 1 kg of acid-treated pig skin gelatin (the product of Nitta Gelatin Inc.) was dissolved, and the temperature of the resulting mixture was adjusted to 60° C. To this mixture, 0.5 to 10.0 g of Papain W-40 (the product of Amano Pharmaceutical Co., Ltd.) was added as a protease. After carrying out enzymatic treatment at pH 5.0 to 6.0 and a temperature of 45 to 55° C., the enzymes were inactivated by heating at 85° C. for 10 minutes. The mixture was then cooled to 60° C. and subjected to microfiltration, followed by spray drying for powderization, whereby a collagen peptide powder was obtained. It was confirmed by measuring molecular weight by the PAGI method that the powder thus obtained was collagen peptides.

### Production Examples 1 to 11

Durum wheat semolina flour (Leone G: Nisshin Flour Milling Inc.) and acetylated tapioca starch (Ajisai; the product of Matsutani Chemical industry Co., Ltd.) or hydroxypropylated tapioca starch (Yuri; the product of Matsutani Chemical industry Co., Ltd.) were mixed in the amounts shown in Table 1 below, and 30 parts by mass of water was added thereto, followed by kneading to obtain a noodle dough. Using a pasta making machine, the dough was extruded under a reduced pressure condition of −600 mmHg to produce fresh macaroni. The fresh macaroni thus obtained was boiled in hot water until a yield of 210% was obtained, then cooled with water, drained and then divided into polyethylene trays at 100 g per tray. To 100 g of the boiled macaroni thus divided, an aqueous solution containing 2% by mass of the collagen peptides of Reference Example 1 was added, followed by thorough mixing to allow 20 g of the aqueous collagen peptide solution to attach to the entire surface of the boiled macaroni. Subsequently, the boiled macaroni attached with the aqueous collagen peptide solution was quickly frozen at −35° C., whereby the frozen cooked macaronis of Production Examples 1 to 11 were produced.

### Test Example 1

The frozen cooked macaronis of Production Examples 1 to 11 were removed from the trays and packed in polypropylene bags, and then stored at −18° C. After three months, the frozen macaronis were removed from the bags and naturally thawed at room temperature of 20° C. The macaronis after thawing were evaluated by 10 panelists based on the evaluation criteria shown in Table 2, and average scores were obtained. The results are shown in Table 1.

TABLE 1

| | | Production Example | | | | | | | | | | |
|---|---|---|---|---|---|---|---|---|---|---|---|---|
| | | 1 | 2 | 3 | 4 | 5 | 6 | 7 | 8 | 9 | 10 | 11 |
| Raw material | Durum semolina | 100 | 95 | 80 | 60 | 40 | 20 | 15 | 95 | 60 | 20 | 15 |
| flour | Acetylated | — | 5 | 20 | 40 | 60 | 80 | 85 | — | — | — | — |
| (% by mass) | tapioca starch | | | | | | | | | | | |
| | Hydroxypropylated | — | — | — | — | — | — | — | 5 | 40 | 80 | 85 |
| | tapioca starch | | | | | | | | | | | |

| | | | | | | | | | | | |
|---|---|---|---|---|---|---|---|---|---|---|---|
| Mouth feel | 2.4 | 4.0 | 4.4 | 4.8 | 4.4 | 4.0 | 2.0 | 4.0 | 4.8 | 4.3 | 2.1 |
| Texture | 1.8 | 3.5 | 4.3 | 4.7 | 4.6 | 4.3 | 2.5 | 3.7 | 4.5 | 4.6 | 2.6 |

TABLE 2

| | | |
|---|---|---|
| Mouth feel | 5 | Mouth feel is very smooth and favorable. |
| of noodles | 4 | Mouth feel is smooth and slightly favorable. |
| | 3 | Mouth feel is slightly smooth |
| | 2 | Mouth feel is slightly less smooth and poor. |
| | 1 | Mouth feel lacks smoothness and is poor. |
| Texture of | 5 | Noodles have an adequately elastic and favorable |
| noodles | | texture without crumbliness. |
| | 4 | Noodles have a slightly crumbly, but elastic and |
| | | favorable texture. |
| | 3 | Noodles have a slightly inelastic, brittle and |
| | | crumbly texture. |
| | 2 | Noodles have inelastic, brittle, and crumbly texture. |
| | 1 | Noodles have an extremely inelastic, brittle, and |
| | | crumbly texture. |

### Production Examples 12 to 19

Except for allowing 20 g of an aqueous solution containing the collagen peptides of Reference Example 1 in the amounts shown in Table 3 to attach to 100 g of boiled macaroni, the frozen cooked macaronis of Production Examples 12 to 19 were produced in the same manner as in Production Example 4.

### Test Example 2

The frozen cooked macaronis of Production Examples 12 to 19 were evaluated in the same manner as in Test Example 1. The results are shown in Table 3. Also, the results of Production Example 4 are shown again in Table 3.

TABLE 3

| | | Production Example | | | | | | | | |
|---|---|---|---|---|---|---|---|---|---|---|
| | | 12 | 13 | 14 | 15 | 16 | 4 | 17 | 18 | 19 |
| Raw material | Durum semolina | 60 | 60 | 60 | 60 | 60 | 60 | 60 | 60 | 60 |
| flour | Acetylated | 40 | 40 | 40 | 40 | 40 | 40 | 40 | 40 | 40 |
| (% by mass) | tapioca starch | | | | | | | | | |

| | | | | | | | | | |
|---|---|---|---|---|---|---|---|---|---|
| Amount of aqueous | 20 | 20 | 20 | 20 | 20 | 20 | 20 | 20 | 20 |
| collagen peptide solution | | | | | | | | | |
| attached (g) | | | | | | | | | |
| Concentration of | 0 | 0.05 | 0.1 | 0.3 | 1.7 | 2.0 | 6.0 | 8.0 | 10.0 |
| aqueous collagen peptide | | | | | | | | | |
| solution (% by mass) | | | | | | | | | |
| Mouth feel | 1.9 | 2.9 | 4.0 | 4.4 | 4.5 | 4.8 | 4.5 | 4.2 | 4.0*¹ |
| Texture | 1.6 | 3.0 | 4.1 | 4.3 | 4.4 | 4.7 | 4.6 | 4.3 | 3.9 |

*¹Poor mouth feel because macaronis stick to each other and have a sticky surface

### Production Examples 20 to 30

Except for allowing 30 g of a sauce containing 2% by mass of the collagen peptides of Reference Example 1 (Neapolitan sauce manufactured by Nisshin Foods Inc.) to attach to 100 g of boiled macaroni in place of an aqueous collagen peptide solution, the frozen cooked macaronis of Production Examples 20 to 30 were produced in the same manner as in Production Examples 1 to 11. Also, using a sauce containing gelatin (GBL-200; the product of Nitta Gelatin Inc.) in place of a collagen peptide-containing sauce, the frozen cooked macaroni was produced in the same manner (Comparative Example 1).

### Test Example 3

The frozen cooked macaronis of Production Examples 20 to 30 and Comparative Example 1 were frozen-stored and then naturally thawed in the same manner as in Test Example 1. The macaronis after thawing were evaluated by 10 panelists based on the evaluation criteria shown in Tables 2 and 5, and average scores were obtained. The results are shown in Table 4.

TABLE 4

| | | Production Example | | | | | | | | | | | Comparative |
|---|---|---|---|---|---|---|---|---|---|---|---|---|---|
| | | 20 | 21 | 22 | 23 | 24 | 25 | 26 | 27 | 28 | 29 | 30 | Example 1 |
| Raw material | Durum semolina | 100 | 95 | 80 | 60 | 40 | 20 | 15 | 95 | 60 | 20 | 15 | 60 |
| flour | Acetylated | — | 5 | 20 | 40 | 60 | 80 | 85 | — | — | — | — | 40 |
| (% by mass) | tapioca starch | | | | | | | | | | | | |
| | Hydroxypropylated | — | — | — | — | — | — | — | 5 | 40 | 80 | 85 | — |
| | tapioca starch | | | | | | | | | | | | |

| | | | | | | | | | | | | |
|---|---|---|---|---|---|---|---|---|---|---|---|---|
| Mouth feel | 2.7 | 4.1 | 4.4 | 4.8 | 4.5 | 4.0 | 2.0 | 3.9 | 4.8 | 4.6 | 2.1 | 3.9 |
| Texture | 2.5 | 3.8 | 4.3 | 4.8 | 4.4 | 4.3 | 2.5 | 3.7 | 4.6 | 4.3 | 2.6 | 3.6 |
| Appearance | 3.1 | 4.4 | 4.6 | 4.7 | 4.8 | 4.3 | 2.6 | 4.2 | 4.5 | 4.5 | 3.1 | 3.9 |
| Loosening | 3.6 | 4.3 | 4.6 | 4.9 | 4.5 | 4.3 | 3.8 | 4.3 | 4.6 | 4.0 | 3.7 | 2.9 |

TABLE 5

| | | |
|---|---|---|
| Appearance of | 5 | Noodles are shiny and have an excellent appearance. |
| noodles | 4 | Noodles are shiny and have a favorable appearance. |
| | 3 | Noodles are shiny but partly dry. |
| | 2 | Noodles are partly dry and slightly less shiny. |
| | 1 | Noodles are largely dry and less shiny. |
| Loosening of | 5 | Noodles are free from lumps and very |
| noodles | | easily loosened. |
| | 4 | Noodles are almost free from lumps and |
| | | easily loosened. |
| | 3 | Noodles are slightly lumpy but loosened. |
| | 2 | Noodles are lumpy and are not loosened partly. |
| | 1 | Noodles form a large lump or have many lumps |
| | | and are particularly not loosened partly. |

### Production Examples 31 to 39

Boiled macaroni was produced by the same procedure as in Production Example 4 and divided into polyethylene trays at 100 g per tray. To 100 g of the boiled macaroni thus divided, a sauce containing the collagen peptides of Reference Example 1 in the amounts shown in Table 6 (i.e., Neapolitan sauce manufactured by Nisshin Foods Inc.) was added (i.e., a sauce to be attached), followed by thorough mixing to allow 30 g of the sauce to attach to the entire surface of the boiled macaroni. On top of the macaroni, 30 g of the same Neapolitan sauce as above was additionally placed (i.e., a sauce to be placed on top), and then the macaronis were quickly frozen at −35° C., whereby frozen cooked macaronis with sauce of Production Examples 31 to 39 were produced. Also, using a sauce containing gelatin (GBL-200; the product of Nitta Gelatin Inc.) in place of a collagen peptide-containing sauce, the frozen cooked macaroni was produced in the same manner (Comparative Example 2).

### Test Example 4

The frozen cooked macaronis of Production Examples 31 to 39 and Comparative Example 2 were evaluated in the same manner as in Test Example 3. The results are shown in Table 6.

TABLE 6

| | | Production Example | | | | | | | | | Comparative |
|---|---|---|---|---|---|---|---|---|---|---|---|
| | | 31 | 32 | 33 | 34 | 35 | 36 | 37 | 38 | 39 | Example 2 |
| Raw material | Durum semolina | 60 | 60 | 60 | 60 | 60 | 60 | 60 | 60 | 60 | 60 |
| flour | Acetylated | 40 | 40 | 40 | 40 | 40 | 40 | 40 | 40 | 40 | 40 |
| (% by mass) | tapioca starch | | | | | | | | | | |

| | | | | | | | | | | |
|---|---|---|---|---|---|---|---|---|---|---|
| Amount of sauce to be | 30 | 30 | 30 | 30 | 30 | 30 | 30 | 30 | 30 | 30 |
| attached (g) | | | | | | | | | | |
| Collagen peptide | 0 | 0.05 | 0.1 | 0.3 | 1.7 | 2.0 | 6.0 | 8.0 | 10.0 | 2.0*² |
| concentration in sauce | | | | | | | | | | |
| to be attached (% by | | | | | | | | | | |
| mass) | | | | | | | | | | |
| Amount of sauce to be | 30 | 30 | 30 | 30 | 30 | 30 | 30 | 30 | 30 | 30 |
| placed on top (g) | | | | | | | | | | |
| Collagen peptide | 0 | 0.05 | 0.1 | 0.3 | 1.7 | 2.0 | 6.0 | 8.0 | 10.0 | 2.0*² |
| concentration in sauce | | | | | | | | | | |
| to be placed on top (% | | | | | | | | | | |
| by mass) | | | | | | | | | | |
| Mouth feel | 1.8 | 2.9 | 4.1 | 4.5 | 4.6 | 4.8 | 4.9 | 4.8 | 4.4*¹ | 3.8 |
| Texture | 1.5 | 3.3 | 4.2 | 4.5 | 4.6 | 4.8 | 4.8 | 4.9 | 4.5 | 3.5 |
| Appearance | 3.2 | 3.3 | 4.0 | 4.3 | 4.6 | 4.7 | 4.9 | 4.9 | 4.4 | 3.7 |
| Loosening | 1.8 | 2.9 | 4.5 | 4.6 | 4.7 | 4.9 | 4.8 | 4.8 | 3.8 | 3.1 |

*¹Poor mouth feel because macaronis stick to each other and has a sticky surface
*²Gelatin concentration (% by mass)

### Production Examples 40 to 48

Except for changing the amounts of a sauce to be attached and a sauce to be placed on top and the contents of collagen peptides as shown in Table 7, the frozen cooked macaronis of Production Examples 40 to 48 were produced in the same manner as in Production Example 35. Also, using a sauce containing gelatin (GEL-200; the product of Nitta Gelatin Inc.) in place of a collagen peptide-containing sauce, the frozen cooked macaroni was produced in the same manner (Comparative Example 3).

### Test Example 5

The frozen cooked macaronis of Production Examples 40 to 48 and Comparative Example 3 were evaluated in the same manner as in Test Example 4. The results are shown in Table 7.

TABLE 7

| | | Production Example | | | | | | | | | Comparative |
|---|---|---|---|---|---|---|---|---|---|---|---|
| | | 40 | 41 | 42 | 43 | 44 | 45 | 46 | 47 | 48 | Example 3 |
| Raw material | Durum semolina | 60 | 60 | 60 | 60 | 60 | 60 | 60 | 60 | 60 | 60 |
| flour | Acetylated | 40 | 40 | 40 | 40 | 40 | 40 | 40 | 40 | 40 | 40 |
| (% by mass) | tapioca starch | | | | | | | | | | |

| | | | | | | | | | | |
|---|---|---|---|---|---|---|---|---|---|---|
| Amount of sauce to be | 6 | 6 | 6 | 6 | 6 | 6 | 6 | 6 | 6 | 6 |
| attached (g) | | | | | | | | | | |
| Collagen peptide | 1.7 | 1.7 | 1.7 | 1.7 | 1.7 | 1.7 | 1.7 | 1.7 | 1.7 | 1.7*¹ |
| concentration in sauce to | | | | | | | | | | |
| be attached (% by mass) | | | | | | | | | | |
| Amount of sauce to be | 12 | 12 | 12 | 12 | 12 | 12 | 12 | 12 | 12 | 12 |
| placed on top (g) | | | | | | | | | | |
| Collagen peptide | 0 | 0.3 | 0.7 | 1.0 | 1.2 | 1.3 | 1.5 | 1.7 | 1.8 | 1.2*¹ |
| concentration in sauce to | | | | | | | | | | |
| be placed on top (% by | | | | | | | | | | |
| mass) | | | | | | | | | | |
| Mouth feel | 3.9 | 4.3 | 4.4 | 4.5 | 4.5 | 4.5 | 4.7 | 4.8 | 4.8 | 3.6 |
| Texture | 3.8 | 4.2 | 4.3 | 4.4 | 4.4 | 4.6 | 4.6 | 4.8 | 4.9 | 3.5 |
| Appearance | 3.9 | 4.4 | 4.4 | 4.5 | 4.6 | 4.6 | 4.7 | 4.9 | 4.8 | 3.6 |
| Loosening | 3.9 | 4.1 | 4.3 | 4.3 | 4.4 | 4.4 | 4.6 | 4.7 | 4.8 | 3.4 |

*¹Gelatin concentration (% by mass)

### Production Examples 49 to 54

Except for changing the amount of a sauce to be attached as shown in Table 8, the frozen cooked macaronis of Production Examples 49 to 53 were produced in the same manner as in Production Example 44.

### Test Example 6

The frozen cooked macaronis of Production Examples 49 to 54 were evaluated in the same manner as in Test Example 4. The results are shown in Table 8. Also, the results of Production Example 44 are shown again in Table 8.

TABLE 8

| | | Production Example | | | | | | |
|---|---|---|---|---|---|---|---|---|
| | | 49 | 50 | 44 | 51 | 52 | 53 | 54 |
| Raw material | Durum semolina | 60 | 60 | 60 | 60 | 60 | 60 | 60 |
| flour | Acetylated | 40 | 40 | 40 | 40 | 40 | 40 | 40 |
| (% by mass) | tapioca starch | | | | | | | |

| | | | | | | | |
|---|---|---|---|---|---|---|---|
| Amount of sauce to be | 0 | 3 | 6 | 10 | 20 | 30 | 50 |
| attached (g) | | | | | | | |
| Collagen peptide concentration | — | 1.7 | 1.7 | 1.7 | 1.7 | 1.7 | 1.7 |
| in sauce to be attached (% by | | | | | | | |
| mass) | | | | | | | |
| Amount of sauce to be placed | 12 | 12 | 12 | 12 | 12 | 12 | 12 |
| on top (g) | | | | | | | |
| Collagen peptide | 1.2 | 1.2 | 1.2 | 1.2 | 1.2 | 1.2 | 1.2 |
| concentration in sauce to | | | | | | | |
| be placed on top (% by | | | | | | | |
| mass) | | | | | | | |
| Mouth feel | 3.9 | 4.2 | 4.5 | 4.7 | 4.7 | 4.6 | 4.1 |
| Texture | 3.7 | 4.2 | 4.4 | 4.8 | 4.8 | 4.6 | 4.2 |
| Appearance | 3.7 | 4.1 | 4.6 | 4.8 | 4.9 | 4.7 | 4.3 |
| Loosening | 3.5 | 4.0 | 4.4 | 4.7 | 4.8 | 4.7 | 4.0 |

### Production Examples 55 to 65

Wheat flour (Toku Suzume; Nisshin Flour Milling Inc.) and acetylated tapioca starch (Ajisai; the product of Matsutani Chemical industry Co., Ltd.) or hydroxypropylated tapioca starch (Yuri; the product of Matsutani Chemical industry Co., Ltd.) were mixed in the amounts shown in Table 9 below and 10% brine (45%) was added thereto, followed by kneading to obtain noodle dough. The resulting dough was rolled out with a roller and cut with a cutting blade (10-count) to produce fresh udon noodles. The fresh udon noodles thus obtained were boiled in hot water until a yield of 250% was obtained, then cooled with water, drained and then divided into polypropylene trays at 100 g per tray. To 100 g of the boiled udon noodles thus divided, 10 g of an aqueous solution containing 2% by mass of the collagen peptides of Reference Example 1 was added, followed by thorough mixing to allow the aqueous collagen peptide solution to attach to the entire surface of the udon noodles. Subsequently, the boiled udon noodles attached with the aqueous collagen peptide solution were quickly frozen at −35° C., whereby the frozen cooked udon noodles of Production Examples 55 to 55 were produced.

### Test Example 8

The frozen cooked udon noodles of Production Example 55 to 55 were removed from the trays and packed in polypropylene bags, and then stored at −18′C. After three months, the frozen udon noodles were removed from the bags and naturally thawed at room temperature of 20° C. The udon noodles after thawing were evaluated by 10 panelists based on the evaluation criteria shown in Table 2, and average scores were obtained. The results are shown in Table 9.

TABLE 9

| | | Production Example | | | | | | | | | | |
|---|---|---|---|---|---|---|---|---|---|---|---|---|
| | | 55 | 56 | 57 | 58 | 59 | 60 | 61 | 62 | 63 | 64 | 65 |
| Raw material | Wheat flour | 100 | 95 | 80 | 60 | 40 | 20 | 15 | 95 | 60 | 20 | 15 |
| flour | Acetylated | — | 5 | 20 | 40 | 60 | 80 | 85 | — | — | — | — |
| (% by mass) | tapioca starch | | | | | | | | | | | |
| | Hydroxypropylated | — | — | — | — | — | — | — | 5 | 40 | 80 | 85 |
| | tapioca starch | | | | | | | | | | | |

| | | | | | | | | | | | |
|---|---|---|---|---|---|---|---|---|---|---|---|
| Mouth feel | 2.0 | 3.9 | 4.4 | 4.8 | 4.3 | 4.0 | 2.9 | 3.8 | 4.7 | 4.3 | 2.3 |
| Texture | 1.8 | 3.9 | 4.3 | 4.8 | 4.5 | 4.3 | 3.0 | 3.9 | 4.8 | 4.6 | 2.6 |

1. A method for manufacturing frozen cooked noodles, the comprising:
gelatinizing noodles produced from raw material flour comprising 5 to 80% by mass of processed tapioca starch;
allowing a composition comprising collagen peptides to attach to the gelatinized noodles thus obtained; and
freezing the noodles attached with the composition.

2. The method according to claim 1, wherein the composition is an aqueous solution or a sauce comprising 0.1 to 8% by mass of collagen peptides.

3. The method according to claim 1, wherein an amount of the composition attached to the gelatinized noodles is 3% by mass or more relative to 100% by mass of the gelatinized noodles.

4. The method according to claim 1, wherein the composition is a sauce comprising collagen peptides and the method further comprises placing another sauce comprising collagen peptides on top of the noodles attached with the sauce comprising collagen peptides.

5. The method according to claim 1, wherein the processed tapioca starch is one or more selected from the group consisting of esterified tapioca starch, etherified tapioca starch and cross-linked tapioca starch.

6. The method according to claim 1, wherein the processed tapioca starch is one or more selected from the group consisting of acetylated tapioca starch and hydroxypropylated tapioca starch.

7. The method according to claim 1, wherein the raw material flour further comprises 18 to 95% by mass of grain flour.

8. A method for manufacturing cooked noodles, the method comprising thawing the frozen cooked noodles manufactured by the method according to claim 1.
